(19) United States
(12) Patent Application Publication
(10) Pub. No.: US 2006/0158979 A1
(43) Pub. Date: Jul. 20, 2006

(54) Recording/reproducing device and recording medium

(75) Inventors: Tadashi Nakamura, Nara-shi (JP); Yasunori Hino, Ikoma-shi (JP); Osamu Okauchi, Hirakata-shi (JP)

Correspondence Address: HAMRE, SCHUMANN, MUELLER & LARSON P.C., P.O. BOX 2902-0902, MINNEAPOLIS, MN, 55402, US

(73) Assignee: Matsushita Electric Industrial Co., Ltd., Osaka (JP)

(21) Appl. No.: 10/563,678

(22) PCT Filed: Sep. 17, 2004
(86) PCT No.: PCT/JP04/14046

§ 371 Date: Jan. 6, 2006

(30) Foreign Application Priority Data
Sep. 18, 2003 (JP) 2003-326521

(51) Int. Cl. G11B 5/09

(52) U.S. Cl. 369/47.1; 369/59.1

(57) ABSTRACT

A recording/reproducing device includes a drive device 303 for recording and reproducing information on and from a disc medium 100 and a recording/reproducing control circuit 305 for controlling operations of the drive device 303. The recording/reproducing control circuit 305 controls the drive device 303 such that medium identification information that enables the disc medium 100 to be distinguished from another disc medium is recorded repeatedly in a plurality of locations in an area where structural characteristic information of the disc medium is recorded within a management data area on the disc medium 100.

### TECHNICAL FIELD

The present invention relates to a recording medium and a recording/reproducing device, and more particularly to recording and reproduction of information unique to a medium, such as medium identification information.

### BACKGROUND ART

Disc media have been popular in recent years as rewritable recording media for recording AV data such as digitalized animated or still image data. For example, AV data that is coded in accordance with a coding standard such as MPEG2 and JPEG or the like is recorded on and reproduced from disc media such as DVDs, hard discs, and MDs (mini-discs).

Various electronic data other than AV data, such as document files and emails or the like, also are stored in disc media.

Technical advancements have increased the recording capacity of disc media over the years and modern disc media generally have a capacity in the order of gigabytes.

FIG. 7 is a diagram illustrating one example of a hierarchical structure of directories and files for managing data recorded on such disc media as files.

Multiple directories and files are recorded starting from the ROOT directory; the data thus can be classified and managed by grouping files by directories.

For example, all still image files can be managed collectively by grouping the files having the “.JPG” extension under the DCIM directory.

While such a directory management system is commonly used, the number and type of digital data stored as files on recording media have increased with the spread of digital devices and network technologies. The number of recording media for storing these data accordingly is increasing.

A technique, therefore, is sought that enables easy management of a large number of recording media and a large amount of files recorded thereon.

In particular, with a conventional rewritable disc medium, it cannot be determined what files are stored on the medium until the medium is inserted in a reproducing device and a list of files is displayed. If a user owns several disc media, it was necessary to reproduce one medium after another until the user finds out on which medium the desired data is present.

Under such circumstances, it is the practice to catalog datafile information of a plurality of disc media and to save the catalog data in a PC (personal computer) or a recording/reproducing device for use with disc media such as a stationary disc recorder device or the like.

FIG. 8(a) and FIG. 8(b) illustrate examples of correspondence between several disc media and catalog data. As shown in FIG. 8(a), a plurality of files is recorded on disc media 1 to 3, respectively.

As shown in FIG. 8(b), the catalog data is constituted by a table of information that distinguishes each disc medium and file identification information (file names, for example) contained in the disc medium. In addition to the datafile identification information, search keywords and attribute information (metadata) such as datafile types also may be stored.

Such catalog data is saved in a hard disc drive (HDD) or a nonvolatile semiconductor memory in a disc recorder device or a PC.

Devices adapted for a catalog data system renew the catalog data each time the file information in the disc medium is changed, so that the devices maintain the most up-to-date information.

A catalog data search function provided in such devices enables users to search a datafile without having to insert the disc media into the device.

After checking on which disc medium the desired datafile actually is recorded by the catalog search system, the user has to actually insert the disc medium into a recording/reproducing device. It is then necessary to identify a specific disc medium on which the actual file is recorded from among the plurality of disc media.

Conventionally, several methods have been proposed for identifying recording media.

In the case with optical discs, which are one type of recording media, for example, serial numbers or lot numbers are recorded in the form of barcodes on the optical discs in the manufacturing process. In another proposed method, IC memory cards are bonded on the surface or a cartridge of recording media to carry identification information of the media.

Patent Document 1 (JP 2000-222743A) proposes a method of recording identification information of disc media by burning out a reflective film on the inner peripheral side of a data area of optical discs using a special laser recording device.

Another method for identifying recording media is a method using a volume label function of a file system. File systems for managing datafiles generally provide a function of setting and maintaining labels (volume labels) to volume spaces to manage data areas on a disc as volume spaces. These volume labels are used as identification information for recording media.

There was also a method wherein a predetermined file was provided in the file system to maintain identification information therein.

In Patent Document 2 (JP 2003-30934A), information recorded in a defect management area (DMA) in a management area of disc media is used as disc identification information.

The DMA is further described now with reference to FIG. 9.

In disc media, a defective sector is substituted by another sector, and this substituting process is called defect management. This improves the reliability of data recorded on the disc media.

The DMA is provided for the purpose of managing information for the defect management mechanism and is made of a disc definition structure (DDS) that defines the structure of the disc medium and a defect management list.

A DDS identifier is stored at the head of the DDS for indicating that the data structure is the DDS, and partition information follows.

Position information (head addresses) of a PDL and an SDL that constitute the defect list is also recorded.

A PDL identifier and an SDL identifier are stored at the heads of the PDL and SDL, respectively, for indicating that the data structures are the head of the PDL and SDL, and list lengths and defect lists (PDL list and SDL list) follow.

The PDL list has a plurality of entries, each entry carrying position information of one defective sector. The SDL list also has a plurality of entries, but each entry is formed of position information of two defective sectors, one being the position information of a defective sector and the other being position information of a spare sector for substituting the defective sector.

In Patent Document 2, such defect list information is used as identification information of recording media, since these defect lists differ from one disc medium to another.

The DMA and its rewriting process also are described in FIG. 8 of Patent Document 3 (JP 2887949).

Information that allows identification of recording media as described above is used in various applications other than as disc catalogs.

For example, it can be used for the management of users' access histories of specific recording media and files, or for selection and management of specific recording media when distributing electronic data to these recording media.

While various methods relating to medium identification information have been proposed as described above, they all have some disadvantages.

The medium identifying method using barcode information requires an optical pickup and a barcode reading device, leading to the reproducing device having a complicated structure. The same applies to the method using IC memory cards bonded on the surface or a cartridge of recording media, since it requires a special reading device.

The method of Patent Document 1 wherein the reflection layers of optical discs are burned using a special laser recording device requires specially designed manufacturing equipment, because of which the manufacturing cost of the disc media is high. Another disadvantage is that the recording is possible only at the time of manufacturing the recording media.

Moreover, while reading is achieved using a single optical pickup unlike the above described method with barcodes, the optical pickup needs an additional access operation because the medium identification information is recorded in a position different from that of normal optical disc management information, which makes the users' waiting time longer at the time when the disc medium is inserted in the recording/reproducing device, reducing the operability.

Furthermore, the reproducing device needs to be equipped with a special reading routine for the reading of the medium identification information.

With the method of maintaining medium identification information such as volume labels as information in the file system, there is a possibility that the information may be rewritten by an erroneous operation or the like of users, since the data is accessible by users. Moreover, since volume labels are deleted when the disc is formatted, such information is not suitable for continuous data management.

With the method of Patent Document 2, since the defect list information itself is changed with the recording and reproducing operations on and from the recording media, it is not suitable to be used as medium identification information for the catalog data. Moreover, since the defect list information itself is not replaced according to the method of Patent Document 2, it is not entirely reliable.

### DISCLOSURE OF INVENTION

In view of the foregoing, it is an object of the present invention to provide a recording medium in which medium identification information is recorded in an area where structural characteristic information of the recording medium is recorded, whereby the reliability of the medium identification information is high, and to provide a recording/reproducing device and a recording/reproducing method that can realize such a recording medium.

To achieve the above object, the recording/reproducing device according to the present invention includes a recording/reproducing portion for performing recording and reproducing of information on and from a recording medium; and a control portion for controlling operations of the recording/reproducing portion, characterized in that the control portion controls the recording/reproducing portion such that medium identification information that enables the recording medium to be distinguished from another recording medium is recorded repeatedly in a plurality of locations in an area where structural characteristic information of the recording medium is recorded within a management data area on the recording medium.

Further, to achieve the above object, the recording/reproducing method according to a first aspect of the present invention is characterized by having a step of accessing an area where structural characteristic information of a recording medium is recorded within a management data area on the recording medium, and a step of repeatedly recording medium identification information, which enables the recording medium to be distinguished from another recording medium, in a plurality of locations in the area where the structural characteristic information is recorded.

The recording/reproducing method according to a second aspect of the present invention is characterized by having a step of accessing an area where structural characteristic information of a recording medium is recorded within a management data area on the recording medium, and a step of reproducing medium identification information that has been recorded repeatedly in a plurality of locations in the area where the structural characteristic information is recorded and that enables the recording medium to be distinguished from another recording medium from at least one of the plurality of locations.

Further, to achieve the above object, the recording medium according to the present invention is a recording medium on which information is recorded, including a user data area where user data is recorded and a management data area where management data is recorded, characterized in that medium identification information that enables the recording medium to be distinguished from another recording medium is recorded repeatedly in a plurality of locations in an area where structural characteristic information of the recording medium is recorded within the management data area.

Further, the host device according to the present invention is a host device that instructs a recording/reproducing device to record and reproduce information using a recording medium, characterized by having a sending/receiving portion for sending and receiving information to and from the recording/reproducing device, and an identification information generating portion for generating at least part of medium identification information that enables the recording medium to be distinguished from another recording medium, the medium identification information being recorded repeatedly in a plurality of locations in an area where structural characteristic information of the recording medium is recorded within a management data area of the recording medium.

According to the present invention, a recording/reproducing device is provided at low cost, which can record highly reliable medium identification information on a recording medium without using a special component or device.

As the medium identification information is maintained the same even if the recording medium is formatted, the recording medium can be identified with certainty all through its life.

Furthermore, since the medium identification information is read out together with the structural characteristic information of the recording medium prior to the recording/reproducing on/from the recording medium, no additional accessing operation is required for reading out the medium identification information, and the device can start operating and output the medium identification information swiftly. This enhances the users' feeling of ease of use. Moreover, this readout process can be realized without making a large change to a conventional device.

### BRIEF DESCRIPTION OF DRAWINGS

FIG. 1 is a diagram illustrating one example of the outer appearance of a recording/reproducing device according to one embodiment of the present invention, and interfaces with related devices.

FIG. 2(a) is a diagram illustrating a recording area of a recordable disc medium, FIG. 2(b) is a diagram in which the lead-in area, lead-out area, and data area illustrated concentrically in FIG. 2(a) are arranged laterally, and FIG. 2(c) is a diagram illustrating a logical data space constituted by logical sectors of a disc medium 100.

FIG. 3 is a diagram illustrating a DMA data structure according to Embodiment 1 of the present invention.

FIG. 4 is a structural block diagram illustrating the functions of the recording/reproducing device according to Embodiment 1 of the present invention.

FIG. 5 is a diagram for explaining one example of a flowchart showing a format operation.

FIG. 6 is a diagram for explaining one example of a flowchart showing an operation to reproduce medium identification information.

FIG. 7 is a diagram illustrating a hierarchical structure of directories and files recorded on a conventional disc medium 100.

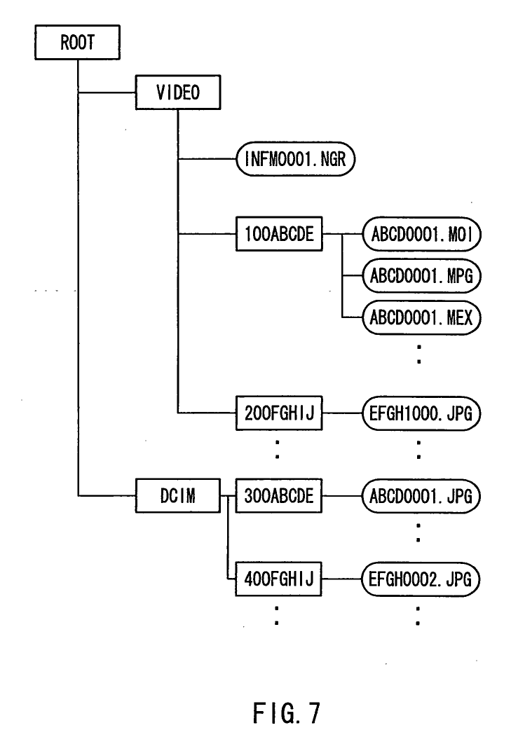

FIG. 8 is a diagram illustrating the concept of conventional catalog data.

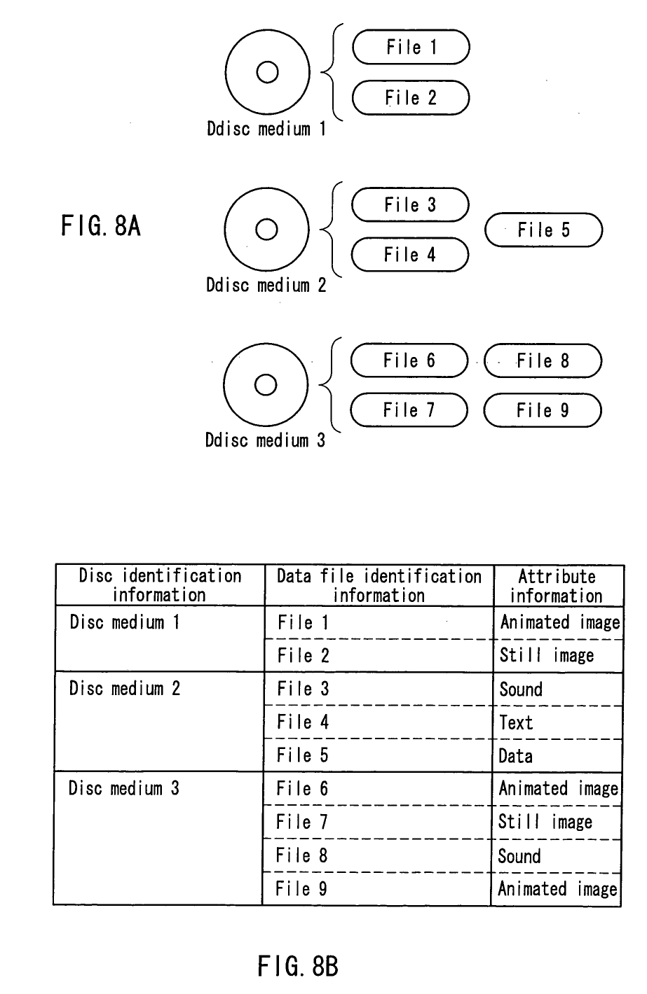

FIG. 9 is a diagram illustrating the data structure of conventional DDS, PDL, and SDL.

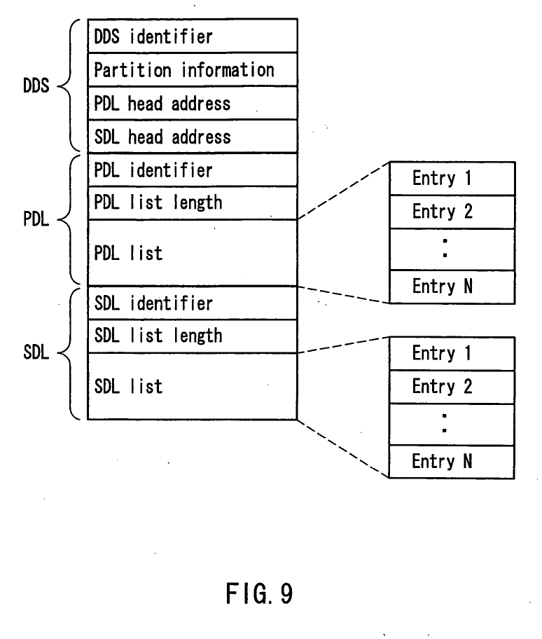

### DESCRIPTION OF THE INVENTION

A recording/reproducing device according to the present invention includes a recording/reproducing portion for performing recording and reproducing of information on and from a recording medium; and a control portion for controlling operations of the recording/reproducing portion, wherein the control portion controls the recording/reproducing portion such that medium identification information that enables the recording medium to be distinguished from another recording medium is recorded repeatedly in a plurality of locations in an area where structural characteristic information of the recording medium is recorded within a management data area on the recording medium. The management data area is an area for recording management data that is different from user data.

The area where the structural characteristic information is recorded is preferably provided in an error correction unit made of a plurality of sectors of the recording medium. The error correction unit is, for example, an ECC block.

Preferably, in the aforementioned configuration, when recording the medium identification information in the area where the structural characteristic information is recorded, the control portion determines whether medium identification information already has been recorded in the area and controls the recording/reproducing portion to perform recording of medium identification information if the medium identification information has not been recorded.

Preferably, the aforementioned configuration further includes an identification information generating portion for generating at least part of the medium identification information, wherein the recording/reproducing portion records the medium identification information based on the information generated by the identification information generating portion.

Alternatively, the aforementioned configuration further may include a sending/receiving portion for sending and receiving information to and from a host device that gives an instruction for the recording and reproducing, wherein the recording/reproducing portion records information containing at least part of information received from the host device via the sending/receiving portion on the recording medium as the medium identification information.

Preferably, in the aforementioned configuration, when recording the medium identification information in the area where the structural characteristic information is recorded, the control portion determines whether medium identification information already has been recorded in the area, and if the medium identification information has been recorded, then the same medium identification information is recorded in the area.

Preferably, the aforementioned configuration further includes a memory, wherein, when formatting the recording medium, the control portion determines whether medium identification information already has been recorded in the area of the recording medium where the structural characteristic information is recorded, and if the medium identification information has been recorded, then the medium identification information is stored in the memory, and after the formatting is complete, the medium identification information stored in the memory is recorded again in the area.

A first recording/reproducing method according to the present invention includes a step of accessing an area where structural characteristic information of a recording medium is recorded within a management data area on the recording medium, and a step of repeatedly recording medium identification information, which enables the recording medium to be distinguished from another recording medium, in a plurality of locations in the area where the structural characteristic information is recorded.

Preferably, the above-noted recording/reproducing method further includes a step of determining whether medium identification information already has been recorded in the area where the structural characteristic information is recorded before recording the medium identification information in the area, and the step of recording the medium identification information is performed when the medium identification information has not been recorded.

Preferably, the above-noted recording/reproducing method further includes a step of generating at least part of the medium identification information before performing the step of recording the medium identification information.

Preferably, the above-noted recording/reproducing method further includes a step of receiving at least part of the medium identification information from a host device before performing the step of recording the medium identification information, and, in the step of recording the medium identification information, recording information containing at least part of information received from the host device on the recording medium as the medium identification information.

Preferably, the above-noted recording/reproducing method further includes a step of determining whether medium identification information already has been recorded in the area where the structural characteristic information is recorded before performing the step of recording the medium identification information, and, if the medium identification information already has been recorded, then the medium identification information identical with the one that already has been recorded is recorded in the area in the step of recording the medium identification information.

Preferably, the above-noted recording/reproducing method further includes: a step of determining whether medium identification information has been recorded in the area where the structural characteristic information is recorded on the recording medium and storing the medium identification information in a memory if the medium identification information has been recorded; a step of formatting the recording medium; and a step of recording the medium identification information stored in the memory again in the area where the structural characteristic information is recorded after the formatting step is complete.

A second recording/reproducing method according to the present invention includes a step of accessing an area where structural characteristic information of a recording medium is recorded within a management data area on the recording medium, and a step of reproducing medium identification information that has been recorded repeatedly in a plurality of locations in the area where the structural characteristic information is recorded and that enables the recording medium to be distinguished from another recording medium from at least one of the plurality of locations.

In the above-noted second recording/reproducing method, the step of reproducing the medium identification information preferably includes a step of trying reproduction of the medium identification information again by accessing another one of the plurality of locations if there is a reproduction error in one of the plurality of locations.

In the above-noted second recording/reproducing method, the step of reproducing the medium identification information preferably includes a step of reproducing all of the structural characteristic information recorded in a plurality of locations of the recording medium, a step of performing an error correction operation on the reproduced structural characteristic information, and a step of extracting medium identification information from structural characteristic information that has undergone the error correction operation and been reproduced normally. Further, the method preferably includes a step of counting the number of pieces of structural characteristic information that have undergone the error correction operation and been reproduced normally and determining that there is an abnormality in the recording medium if the number does not satisfy a predetermined standard.

A recording medium according to the present invention is a recording medium on which information is recorded, including a user data area where user data is recorded and a management data area where management data is recorded, wherein medium identification information that enables the recording medium to be distinguished from another recording medium is recorded repeatedly in a plurality of locations in an area where structural characteristic information of the recording medium is recorded within the management data area.

In the above-noted recording medium, the area where the structural characteristic information is recorded preferably is provided in an error correction unit made of a plurality of sectors of the recording medium. The error correction unit is, for example, an ECC block.

A host device according to the present invention is a host device that instructs a recording/reproducing device to record and reproduce information using a recording medium, and includes a sending/receiving portion for sending and receiving information to and from the recording/reproducing device, and an identification information generating portion for generating at least part of the medium identification information that enables the recording medium to be distinguished from another recording medium, the medium identification information being recorded repeatedly in a plurality of locations in an area where structural characteristic information of the recording medium is recorded within a management data area of the recording medium.

Specific embodiments of the present invention will be hereinafter described with reference to the accompanying drawings.

### Embodiment 1

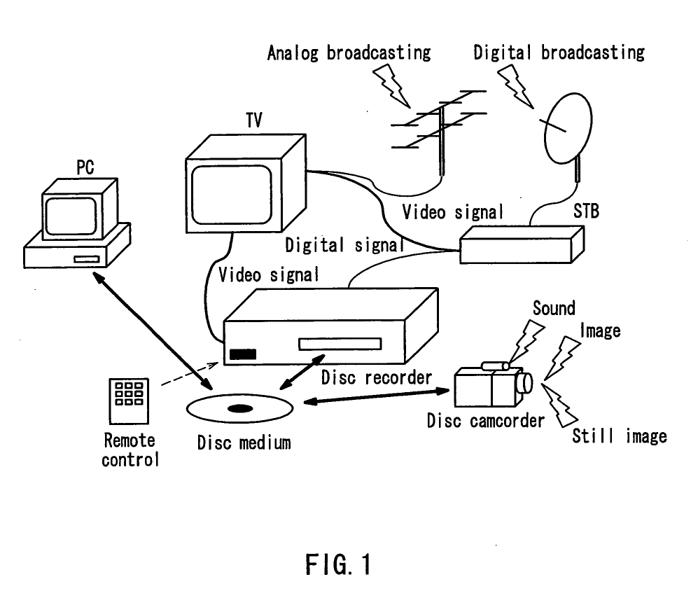

FIG. 1 is a diagram for explaining one example of the outer appearance of a disc recorder device, which is one example of the recording/reproducing device of the invention, and interfaces with related devices.

As shown in FIG. 1, a disc medium as a recording medium is loaded in the disc recorder device for recording and reproducing of video information or the like.

The video information received by the disc recorder device includes analog broadcasting signals and digital broadcasting signals. Generally, analog broadcasting is received and demodulated by a receiver built in a television set and input to the disc recorder device as an analog video signal such as NTSC or the like. Digital broadcasting is demodulated to a digital signal by a STB (Set Top Box) serving as a receiver and is input to the disc recorder device and recorded.

The disc recorder device also has the function of reproducing the video information recorded on the disc medium and outputting the reproduced video information to the outside. As with the input signal, the output signal includes both the analog signal and digital signal. The analog signal is input directly to the television set, and the digital signal first is converted into an analog signal by the STB and input to the television set to be displayed on the television set as images.

Another example of the recording/reproducing device using disc media is a disc camcorder device. A disc camcorder device has both a disc recorder device and a camera device including a lens and CCDs combined, and animated image information captured by the camera device is encoded and recorded on the disc medium.

A further example of the recording/reproducing device of the present invention is a recording/reproducing device as a peripheral device of a personal computer (PC) for recording, reproducing, and editing or the like of video information and other data on the PC.

The video information generally is animated images but may be audio information or still images. For example, still images may be recorded by a photographing function of the disc camcorder device.

The digital interface between a recording/reproducing device and other devices (such as STB, PC and the like) includes IEEE1394, ATAPI, SCSI, USB, wired LAN such as Ethernet (registered trademark), and wireless LAN.

The catalog data mentioned in the description of the background art is maintained in a HDD or nonvolatile semiconductor memory built in a disc recorder device, disc camcorder device, and PC or the like. Alternatively, the catalog data may be stored in a removable recording medium such as a specific disc medium or semiconductor memory.

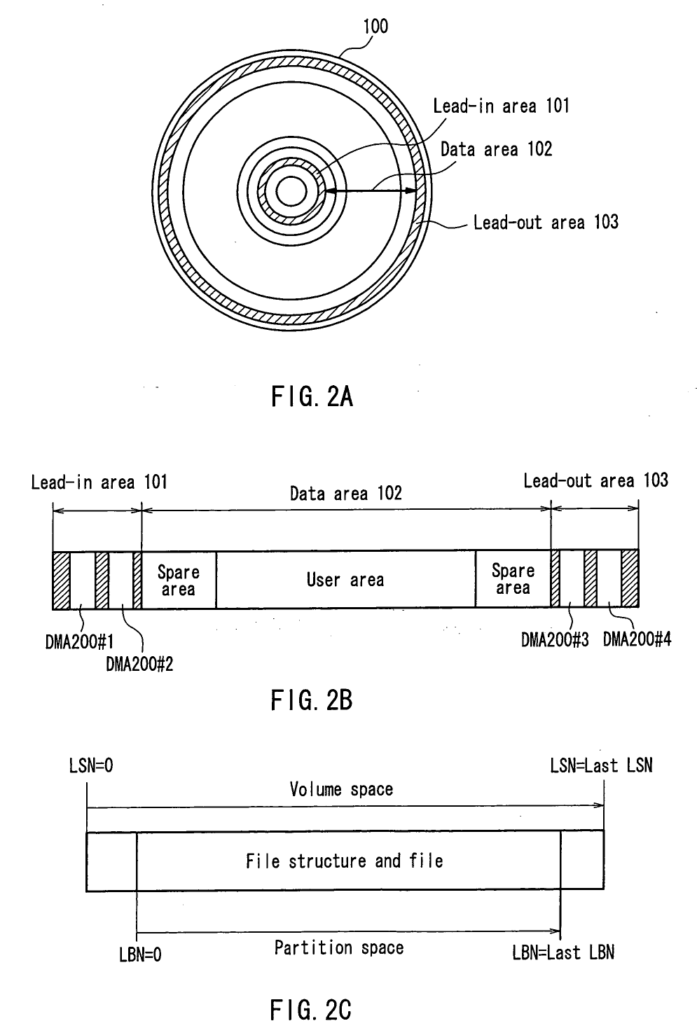

FIG. 2(a) and FIG. 2(b) are diagrams illustrating the outer appearance and the data structure of a disc medium, which is one example of the recording medium of the present invention. Although not shown in the drawings, some disc media such as DVD-RAM may be loaded in the recording/reproducing device in a state in which they are encased in cartridges for the purpose of protecting the recording layer.

FIG. 2(a) is a diagram illustrating one example of a recording area of a recordable disc medium 100. In the example of FIG. 2(a), a lead-in area 101, which is a management data area, is located at the innermost circumference, a lead-out area 103 is located at the outermost circumference, and a data area 102, which is a user data area, is located therebetween.

In the lead-in area 101, reference signals required for stabilizing servo control during the access time of the optical pickup for the recording and reproducing of data on and from the disc medium 100, and other various signals have been recorded. Reference signals similar to those in the lead-in area 101 also are recorded in the lead-out area 103.

FIG. 2(b) is an explanatory diagram in which the lead-in area 101, data area 102, and lead-out area 103 shown concentrically in FIG. 2(a) are arranged in a lateral direction.

The lead-in area 101, data area 102, and lead-out area 103 are managed using a unit called physical sector, and access and data allocation to each area are achieved using these physical sectors as units. Continuous physical sector numbers (PSN) are assigned to the physical sectors.

A plurality of physical sectors constitute one ECC (error correction code) block, which is also referred to as ECC cluster. By performing error correction per each ECC block, the reliability of recorded/reproduced data is improved.

The sector size is 2 KB and sixteen sectors constitute one ECC block in the case of a DVD-RAM disc, which is one example of a disc medium. The sector size depends on the type of the disc medium 100 and may be 512 B (byte), or 8 KB, or the like.

Similarly, one ECC block may consist of any of one sector, sixteen sectors, thirty-two sectors, and so forth. With the increase in the storage capacity density of recording media in future, the sector size and the number of sectors that constitute one ECC block are expected to increase.

In the area where the physical sectors are allocated, the sectors used for the recording of user data are managed as logical sectors. Continuous logical sector numbers (LSN) are assigned to the logical sectors so that these sectors are managed.

The lead-in area 101 and the lead-out area 102 include a plurality of defect management areas (DMA) therein.

The DMA is an area where defect position information indicating the positions of defective physical sectors (or ECC blocks) on the disc medium and spare position information indicating which of the spare areas to be described later has spare physical sectors (or ECC blocks) for substituting the defective sectors (or blocks) is recorded.

While sectors are used as units in the defect management mechanism described below, the defect management may be performed using ECC blocks as units.

When using ECC blocks as units to perform the defect management, the defect position information and spare position information are the positions of the head physical sectors of corresponding ECC blocks, respectively.

The data area 102 has a spare area and a user area therein. The spare area is an area used in place of a defective sector when there is one, and is provided in a specific area in the data area. The user area is an area that can be used as a recording area by a file system.

FIG. 2(c) is a diagram illustrating the logical data space of the disc medium formed in the logical sector space. The logical data space is referred to as a volume space, and user data such as datafiles is recorded therein.

Data recorded in the volume space is managed with a file system. That is, information for managing a group of sectors storing data as a file, and information for managing a group of files as a directory, are recorded in partition spaces in the volume space, and volume structure information for managing partition spaces and the like is recorded at the head and end of the volume area.

The file system generally used in disc media such as DVD-RAM is called UDF and conforms to ISO13346. In the partition spaces of UDF, logical block numbers (LBN) are assigned to each unit of data access for allocation and management of data.

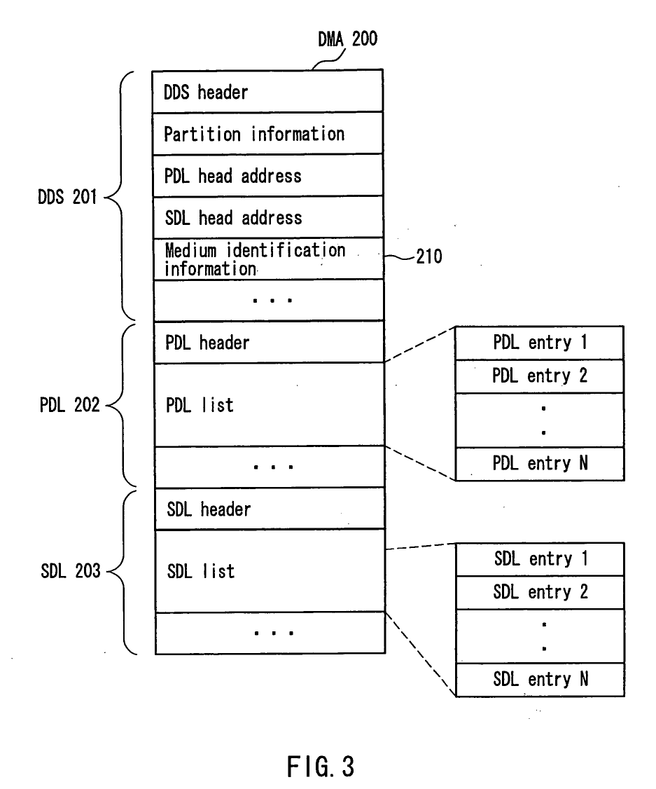

FIG. 3 is a diagram illustrating one example of the DMA data structure in the present embodiment.

The DMA 200 includes a DDS (Disc Definition Structure) 201 that defines structural characteristic information of the disc medium 100, and a PDL 202 and an SDL 203, which are defect lists.

The DDS 201 is made of a DDS header, partition information, position information (head address) of the defect lists, medium identification information 210, and the like.

The DDS header includes a DDS identifier indicating that the sector is a DDS, a renewal number counter that is added to every time the data of the DDS 201 or PDL 202 is rewritten, and the like.

The partition information contains the start addresses and capacities of spare areas in the disc medium, the usage situation of the spare areas, the start address of the user area, and the like.

The medium identification information 210 is the information unique to the disc medium; a serial number, a random number, a lot number, or a manufacturers code or the like of the manufacturer that manufactured the disc medium is recorded as the information for distinguishing the disc medium from other disc media by the recording/reproducing device of this embodiment, which will be described later. The medium identification information 210 further includes flag information indicative of the validity of the contained information.

The PDL 202 contains a PDL header and a list of PDL entries (PDL list). The PDL header includes an identifier indicating that the sector is the head of a PDL, the length of the PDL list, and the like. The PDL list has a plurality of PDL entries, each PDL entry having position information of one defective sector. Defective sectors detected during certification (disc inspection) are registered in the PDL list.

The SDL 203 contains an SDL header and a list of SDL entries (SDL list) at the head. The SDL header includes an identifier indicating that the sector is the head of an SDL, a renewal number counter that is added to every time the data of the SDL 203 is rewritten, the length of the SDL list, and the like. The SDL list has a plurality of SDL entries, each SDL entry constituted by position information of two sectors.

A first position information is information on the position of a defective sector and a second position information indicates the position of a spare sector in the spare area for substituting the defective sector.

As shown in FIG. 2(b), the DMA 200 data is recorded repeatedly in a plurality of locations in the lead-in area 101 and the lead-out area 103 of the disc medium 100 (DMA 200_{#1}-DMA 200_{#4}). Thereby, the reliability of the DMA data is ensured. While the DMA 200 data is recorded repeatedly in four locations (two each in the lead-in area 101 and the lead-out area 103) in the example of FIG. 2(b), the DMA recording locations are not limited to this example. For example, the DMA data may be recorded in three or more locations each in the lead-in area 101 and the lead-out area 103 respectively. Alternatively, the DMA data may be recorded in two or more locations in either one of the lead-in area 101 and the lead-out area 103, or in two locations (one each in the lead-in area 101 and the lead-out area 103 respectively).

The DDS 201 and PDL 202 are recorded during the formatting (disc initialization) process, and the SDL 203 is renewed when a defective sector is detected in the formatting process and recording/reproducing processes.

The DDS 201, PDL 202, and SDL 203 are each recorded in independent ECC blocks.

To make their data capacity conform to the capacity of the ECC blocks, a reserve area is provided at the end of each structure, which is filled with, for example, 00h. Alternatively, some medium intrinsic information other than the medium identification information 210 may be recorded instead of providing the reserve area. The medium intrinsic information other than the medium identification information 210 includes, for example, information regarding laser power at the time of recording or reproducing of the disc medium 100, or the like.

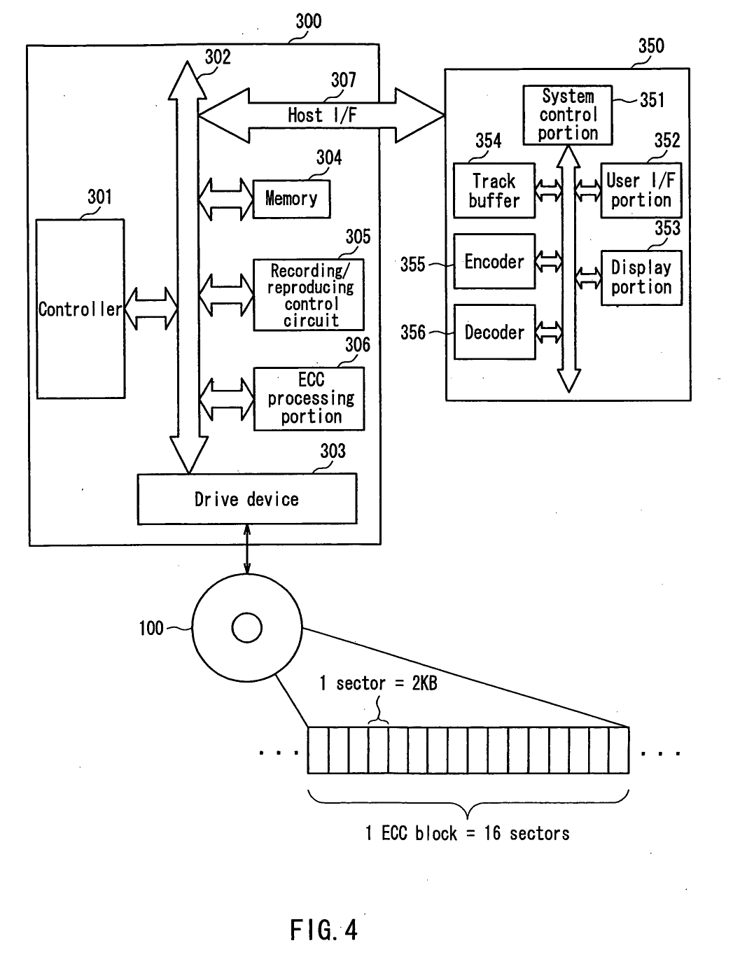

FIG. 4 is a block diagram illustrating one example of the structure of the recording/reproducing device 300 of this embodiment. The recording/reproducing device 300 records or reproduces data on or from the disc medium 100 in accordance with instructions from a host portion 350.

A controller 301 is a circuit that controls the entire recording/reproducing device 300 using a control program stored therein via an inner bus 302.

A drive device 303 (recording/reproducing portion) includes an optical pickup or the like (not shown) and executes the recording and reproducing operations on and from the disc medium 100.

A memory 304 is a memory circuit for maintaining various types of data. For example, the memory 304 temporarily maintains sector data read out from the disc medium 100, temporarily maintains data before it is recorded on the disc medium 100, or maintains temporary information when the controller 301 is performing an operation.

As will be described later, the memory 304 also is used for maintaining data read out from the DMA 200_{#1}-200_{#4} of the disc medium 100 and information for managing the condition of these data.

A recording/reproducing control circuit 305 (control portion) controls the drive device 303 to record data on the disc medium 100, reproduce data, or demodulate address data in accordance with instructions from the controller 301.

An ECC processing portion 306 applies an error correction code to recorded data made of a plurality of sector data in the data recording operation, and performs an error correction operation on reproduced data made of a plurality of sector data in the data reproducing operation. When an uncorrectable error is detected during the data reproducing operation, the ECC processing portion 306 notifies the controller 301 of the fact that the error is uncorrectable.

A host I/F 307 is an interface such as SCSI or ATAPI connected to the host portion 350 and this controls the transfer of commands, user data, or status to/from the host portion 350.

The host portion 350 is other parts constituting the device such as a disc recorder device, PC and the like including the recording/reproducing device 300 and includes, for example, a system control portion 351 for controlling the entire system, a user I/F portion 352, a display portion 353, a track buffer 354 that enables continuous recording/reproducing of AV data, an AV data encoder 355, a decoder 356, and the like.

Next, various operations performed to the disc medium 100 will be generally described with reference to FIG. 4.

Recording to the User Area

First, the recording of data to the user area of the disc medium 100 is described.

When recording data in the user area, a recording command (order) and the data to be recorded are sent from the host portion 350 via the host I/F 307.

The controller 301 interprets the recording command received from the host portion 350 and stores the data to be recorded in the memory 304 via the inner bus 302.

The controller 301 controls the ECC processing portion 306 to attach an error correction code to each group of data consisting of a plurality of sectors that is stored in the memory 304.

The controller 301 controls the recording/reproducing control circuit 305 and the drive device 303, and records the data read out from the memory 304 via the inner bus 302, to which data the error correction code has been attached, in the sector positions instructed by the recording command.

Recording of DMA Data

Next, the recording of DMA data to the disc medium 100 is described.

The controller 301 interprets the parameters of the recording command to determine that recording of DMA data is necessary.

The controller 301 controls the ECC processing portion 306 and attaches an error correction code to data stored in the memory 304 to be recorded in the DMA.

The controller 301 controls the recording/reproducing control circuit 305 and the drive device 303 and records the data read out from the memory 304 via the inner bus 302, to which data the error correction code has been attached, in the area for recording the DMA data in the disc medium 100.

Reproduction from the User Area

Next, the reproduction of data from the user area is described.

When reproducing data from the user area, a reproducing command is sent from the host portion 350 via the host I/F 307.

When the controller 301 recognizes the reception of the reproducing command, it controls the recording/reproducing control circuit 305 to reproduce data of a capacity instructed by the reproducing command from the position on the disc medium 100 instructed by the reproducing command and to forward the data to the ECC processing portion 306 via the inner bus 302. The ECC processing portion 306 performs error correction of the reproduced data and stores the data in the memory 304.

The controller 301 then transfers the reproduced data from the memory 304 to the host portion 350 via the inner bus 302 and the host I/F 307.

Reproduction of DMA Data

Next, the reproduction of DMA data is described.

The controller 301 interprets the parameters of the reproducing command to determine that reproduction of DMA data is necessary.

The controller 301 controls the recording/reproducing control circuit 305 to reproduce data from the DMA, controls the ECC processing portion 306 via the inner bus 302 to perform error correction, and stores the data in the memory 304.

Verifying Operation

Next, the verifying operation is described.

The verifying operation is a process of confirming that data has been recorded correctly after a recording operation to the disc medium 100, by reproducing data from the disc medium 100 similarly to the normal reproducing operation.

Format Operation

Next, the format operation for the disc medium 100 is described. The format operation is an initializing process of the disc medium 100.

The DDS 201, PDL 202, and SDL 203 are recorded in each DMA during the format operation. The format operation will be described in further detail later.

Startup Operation

Next, the startup operation is described.

Startup operation is a process of reading out management information of the disc medium 100 including the DMA data at the time of resetting the recording/reproducing device 300 or changing one disc medium 100 to another, so that recording and reproducing of data are executed on and from the disc medium 100.

SDL Renewal Operation

Next, the SDL renewal operation is described.

The SDL renewal operation is a process of renewing the SDL information on the disc medium 100 when a new defective sector is detected during the recording and reproducing operations of data on and from the disc medium 100.

Renewal of the SDL information is to add a new entry (management information of the detected defective sector) to the SDL list shown in FIG. 3.

The foregoing is a general description of the principal operations of the recording/reproducing device 300 according to the present embodiment.

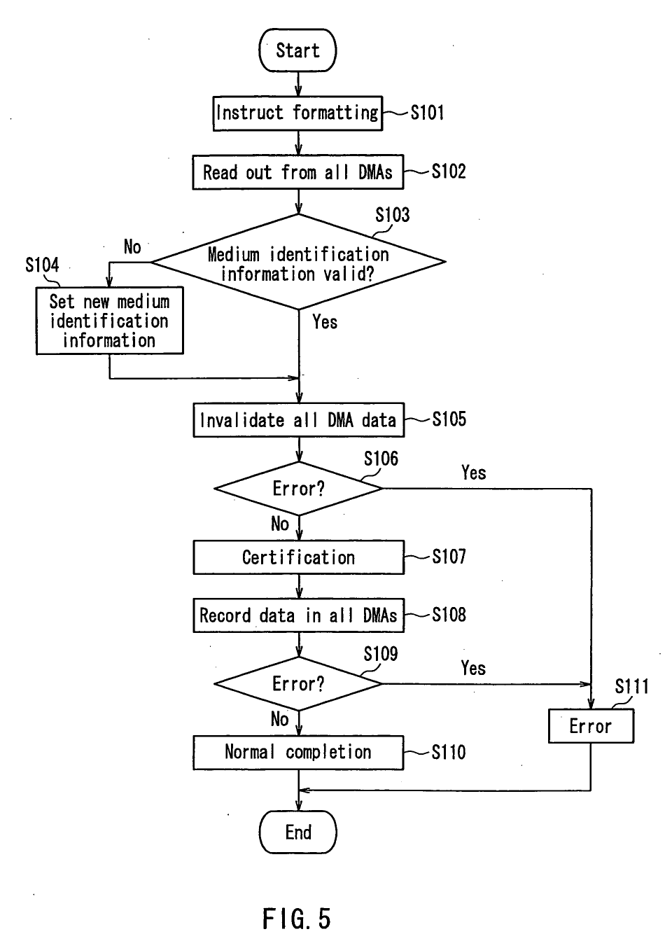

Next, the formatting process performed by the recording/reproducing device 300 of this embodiment is described below in detail with reference to the flowchart of FIG. 5.

S101: Format Parameter Setting

The host portion 350 issues a format command that defines format parameters, which are format operation control parameters, to the recording/reproducing device 300.

The controller 301 receives and interprets the format command to obtain format parameters.

The format operation from here onwards is executed in accordance with the format parameters.

The format parameters include, for example, an instruction as to whether the certification should be performed or not, as will be described later, the permissible number of DMAs having a defective sector, and the like.

The format parameters further include parameters regarding the recording of the medium identification information 210. These parameters include a selection parameter that defines whether new medium identification information 210 should be recorded when no medium identification information 210 has been recorded, a parameter that defines a method for generating the medium identification information to be recorded when new medium identification information 210 should be recorded, and the like.

The parameter that defines the method for generating the new medium identification information 210 is a selection parameter that defines whether the medium identification information 210 should be generated inside the recording/reproducing device 300 or given from the host portion 350. When the medium identification information 210 is to be given from the host portion 350, the values of the medium identification information 210 themselves may be included in the format parameters.

When no specific format parameters have been given, i.e., when the host portion 350 has been instructed to perform a format operation with default values, the controller 301 selects the default values of the format parameters stored therein.

In the description with reference to FIG. 5, it is assumed that the host portion 350 has been instructed to perform a format operation with default values.

S102: Reading-Out of All DMA Data

The controller 301 reads out data of all the DMAs in the order of DMA 200_{#1}, 200_{#2}, 200_{#3}, and 200_{#4}.

S103: Medium Identification Information Validity Check

The controller 301 examines whether the medium identification information 210 contained in the DMA data read out at step S102 is valid or not.

The flag information included in the medium identification information 210 indicative of the validity of the information makes it possible to determine whether valid medium identification information 210 has been recorded or not. Alternatively, such determination can be made if a predetermined value indicative of invalidity of the medium identification information 210 has been recorded in a corresponding sector. For example, a value such as 00h may be defined as data indicative of invalidity and recorded.

The processing of the medium identification information 210 is then determined in accordance with the format parameters. As noted above, default values are used in the format operation described here.

The default processing of the medium identification information 210 is performed as follows, for example: If the DMA data does not include valid medium identification information 210, new values are set, and if the DMA data includes valid values, these values are maintained.

Thus, referring to FIG. 5, if the controller 301 determines that valid medium identification information 210 has already been recorded, then the medium identification information 210 is not changed and is maintained in the memory 304, and the procedure goes to step S105. If it is determined that no valid medium identification information 210 has been recorded, then the procedure goes to step S104.

S104: Setting of New Medium Identification Information

The controller 301 determines new values of medium identification information 210 to be recorded. The method for determining the new medium identification information 210 is designated by the format parameters.

Here, the description will be made of the case where the method of generating the medium identification information 210 by the controller 301 has been designated as the default determining method.

In the case where the controller 301 determines the values of the medium identification information 210, the controller 301 generates such values that enable a plurality of media to be distinguished from each other.

One method of generating such values is, for example, to use time information at that time, a MAC address maintained in a digital interface circuit itself such as Ethernet (registered trademark) and IEEE1394 or the like, and a device ID or the like as the medium identification information. These values may be used as medium identification information as they are, or they may undergo some arithmetic operation.

While it is desirable to ensure that no two medium identification information are identical, other methods of determining the values of the medium identification information 210 may be employed as long as it is possible to distinguish a plurality of media from each other without any problems in actual use, by using a sufficiently large number of digits of a random number, serial number, or the like.

The medium identification information values determined here are set in the DDS data in the memory 304.

S105: Invalidation of All the DMA Data

The controller 301 invalidates the data of all the DMAs 200 in the order of DMA 200_{#1}, 200_{#2}, 200_{#3}, and 200_{#4}. That is, the controller 301 records invalid data in each DMA. For example, an invalid data value such as 00h or FFh is recorded in the DMA as dummy data.

In the sector in which the medium identification information 210 is to be recorded, however, the values maintained in the memory 304 at step S103 or S104 are recorded in the same sector again.

By invalidating all the DMA data at this time point, it is possible to prevent loss of the medium identification information 210 that has been determined even in the event of an unexpected interruption during the processing, which is to be described later. It is also possible to prevent contradictions from occurring within the DMA data.

S106: Error Check

If there is an error during the recording of data for the invalidation of the DMA data or the verifying process afterwards, it is determined as a format error and the procedure goes to step S111. Otherwise, the procedure goes to S107.

Certification

When certification is designated to be executed by the format parameters, the recording process of test data to the entire user area and the verifying process are executed. Management information of defective sectors detected in these processes are maintained in the PDL data in the memory 304.

S108: Recording to All DMAs

The controller 301 generates DMA data in accordance with the results of the certification and saves the data in the memory 304. The controller 301 also sets the medium identification information 210 values maintained in the memory 304 in step S103 or S104 in the DMA data in the memory 304. The controller 301 then records the DMA data saved in the memory 304 in all of the DMAs in the order of DMA 200_{#1}, 200_{#2}, 200_{#3}, and 200_{#4}.

S109: Error Check

If there is an error during the recording of DMA data or the verifying process afterwards, it is determined as a format error and the procedure goes to step S111. Otherwise, the procedure goes to S110.

S110: Report of Normal Completion

The controller 301 reports to the host portion 350 of a normal completion of the command.

S111: Error Report

The controller 301 reports to the host portion 350 of a format error.

The formatting process is executed in the recording/reproducing device 300 in the above procedure.

By the above procedure, information unique to the recording medium such as the medium identification information 210 is provided in the DDS and recorded repeatedly in a plurality of locations on the disc medium 100. Thus the medium identification information 210 is recorded with high reliability without using a special device.

In step S104 in the above description, the controller 301 generates the medium identification information 210 by default. However, determination of the medium identification information 210 is not limited to the methods described above. For example, the host portion 350 may provide the recording/reproducing device 300 with specific values of the medium identification information 210 in the form of format command parameters or a special command. Alternatively, the medium identification information 210 may be formed from a combination of some medium identification information 210 values given from the host portion 350 and some medium identification information 210 values generated inside the recording/reproducing device 300.

With the above-described format parameters, the controller 301 may be set such that, no new medium identification information 210 is recorded even when valid medium identification information 210 has not been recorded. In this case, the procedure goes from step S103 to S105 even when the medium identification information 210 is invalid and the process steps that follow are performed likewise with invalid medium identification information 210.

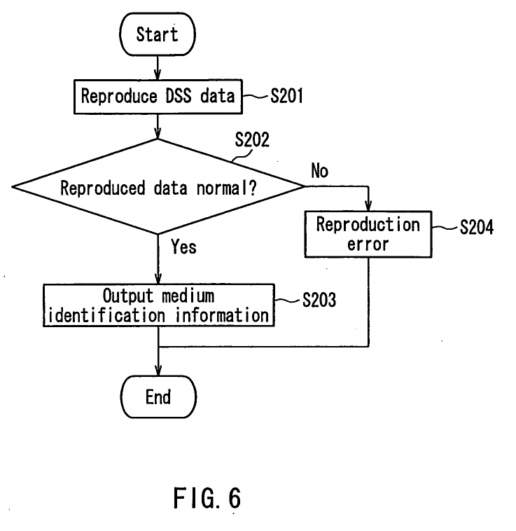

Next, a description will be made below with reference to the flowchart of FIG. 6 as to the medium identification information reproducing process in which the recording/reproducing device 300 of this embodiment reproduces the medium identification information 210 at the time of reset or disc insertion, or due to a command or the like from the host portion 350.

S201: DDS Data Reproduction

The controller 301 controls the recording/reproducing control circuit 305 to reproduce the DDS 201 data and stores the data in the memory 304.

S202: Reproduced Data Check

The ECC processing portion 306 performs an error correction operation to the DDS 201 data to check if the reproduced data is correct or not.

S203: Medium Identification Information Output

When the DDS 201 data is reproduced correctly, the controller 301 extracts medium identification information 210 from the DDS data in the memory 304 and forwards the medium identification information 210 to the host portion 350 via the host I/F 307.

S204: Reproduction Error Report

If the DDS 201 data is not reproduced correctly, then the controller 301 reports the occurrence of a reproduction error to the host portion 350.

In the event of a reproduction error, the DDS 201 data is read out again from a different one of the DMA 200 data that has been recorded repeatedly in a plurality of locations of the disc medium 100 and the steps described in the foregoing are repeated. For example, if there is an error during reproduction from the DMA 200_{#1} for the first time, then the DDS 201 data is reproduced again from the DMA 200_{#2}.

If the DDS 201 data is not reproduced correctly from all of the DMAs on the disc medium 100, then the controller 301 reports to the host portion 305 of a medium error.

Alternatively, the DDS data may be reproduced from all of the DMAs 200_{#1}-200_{#4} in the first place before the error correction operation, after which medium identification information 210 may be extracted from the DDS data that has been reproduced correctly.

In this case, the number of DDS data reproduced correctly may be counted, and it may be determined to be a medium error if that number does not exceed a predetermined standard.

The process of reproducing the medium identification information 210 from the DDS 201 data that is recorded repeatedly in the disc medium 100 thus is executed in the procedure described above.

If the disc medium 100 is provided with a defect management structure, then its DMA is always accessed when the disc medium 100 is inserted to read out correct data. Since data on the disc medium 100 is read out in units of ECC blocks, if the medium identification information 210 is stored in the DDS, then it is immediately recognized when the disc medium 100 is inserted.

This enables a swift response to a command from the host portion 350 to reproduce the medium identification information 210, and offers high convenience in various applications where the medium identification information 210 is used (for example, in cataloging datafiles in the disc medium, or the like).

Moreover, since a recording/reproducing device generally has a function of reading out DDS data, the function of reading out the medium identification information 210 can be achieved without making a large addition to the processing routine.

Next, the process of renewing the SDL 203 is described.

When a new defective sector is detected during the recording or reproducing process on or from the disc medium 100, the defective sector is registered in the SDL 203 and a spare sector is assigned.

Since the DDS 201, PDL 202, and SDL 203 respectively are recorded in independent ECC blocks as described above, the SDL 203 can be rewritten without affecting the DDS 201 and PDL 202. Therefore, the medium identification information 210 that is once recorded cannot be destroyed during the normal recording/reproducing of data and a high level of reliability thus is maintained.

While the medium identification information 210 is recorded at the time of formatting in the procedure shown in FIG. 5, this is not a requirement and the medium identification information 210 alone may be recorded independently of the formatting process by an instruction or the like from the host portion 350 using a special command.

While the DDS 201, PDL 202, and SDL 203 are recorded in the DMA 200 in the above-described embodiment, there also may be disc media 100 that do not include the PDL 202.

### INDUSTRIAL APPLICABILITY

The recording medium according to the present invention includes information unique to the medium (such as medium identification information) and it is useful in applications where the recording medium must be distinguished from other media, for example, in making disc catalogs, managing usage histories of the recording medium, and the like.

1. A recording/reproducing device comprising:
a recording/reproducing portion for performing recording and reproducing of information on and from a recording medium; and
a control portion for controlling operations of the recording/reproducing portion,
wherein the control portion controls the recording/reproducing portion such that medium identification information that enables the recording medium to be distinguished from another recording medium is recorded repeatedly in a plurality of locations in an area where structural characteristic information of the recording medium is recorded within a management data area on the recording medium.

2. The recording/reproducing device according to claim 1,
wherein the area where the structural characteristic information is recorded is provided in an error correction unit made of a plurality of sectors of the recording medium.

3. The recording/reproducing device according to claim 2, wherein the error correction unit is an ECC block.

4. The recording/reproducing device according to claim 1,
wherein, when recording the medium identification information in the area where the structural characteristic information is recorded, the control portion determines whether medium identification information already has been recorded in the area and controls the recording/reproducing portion to perform recording of medium identification information if the medium identification information has not been recorded.

5. The recording/reproducing device according to claim 1, further comprising:
an identification information generating portion for generating at least part of the medium identification information,
wherein the recording/reproducing portion records the medium identification information based on the information generated by the identification information generating portion.

6. The recording/reproducing device according to claim 1, further comprising:
a sending/receiving portion for sending and receiving information to and from a host device that gives an instruction for the recording and reproducing,
wherein the recording/reproducing portion records information containing at least part of the information received from the host device via the sending/receiving portion on the recording medium as the medium identification information.

7. The recording/reproducing device according to claim 1,
wherein, when recording the medium identification information in the area where the structural characteristic information is recorded, the control portion determines whether medium identification information has already been recorded in the area, and if the medium identification information has been recorded, then the same medium identification information is recorded in the area.

8. The recording/reproducing device according to claim 1, further comprising a memory,
wherein, when formatting the recording medium, the control portion determines whether medium identification information has been recorded in the area of the recording medium where the structural characteristic information is recorded, and if the medium identification information has been recorded, then the medium identification information is stored in the memory, and after the formatting is complete, the medium identification information stored in the memory is recorded again in the area.

9. A recording/reproducing method comprising:
a step of accessing an area where structural characteristic information of a recording medium is recorded within a management data area on the recording medium; and
a step of repeatedly recording medium identification information that enables the recording medium to be distinguished from another recording medium in a plurality of locations in the area where the structural characteristic information is recorded.

10. The recording/reproducing method according to claim 9,
wherein the area where the structural characteristic information is recorded is provided in an error correction unit made of a plurality of sectors of the recording medium.

11. The recording/reproducing method according to claim 10, wherein the error correction unit is an ECC block.

12. The recording/reproducing method according to claim 9, further comprising:
before recording the medium identification information in the area where the structural characteristic information is recorded, a step of determining whether medium identification information has already been recorded in the area,
wherein the step of recording the medium identification information is performed when the medium identification information has not been recorded.

13. The recording/reproducing method according to claim 9, further comprising:
before performing the step of recording the medium identification information, a step of generating at least part of the medium identification information.

14. The recording/reproducing method according to claim 9, further comprising:
before performing the step of recording the medium identification information, a step of receiving at least part of the medium identification information from a host device,
wherein, in the step of recording the medium identification information, information containing at least part of information received from the host device is recorded on the recording medium as the medium identification information.

15. The recording/reproducing method according to claim 9, further comprising:
before performing the step of recording the medium identification information, a step of determining whether medium identification information has already been recorded in the area where the structural characteristic information is recorded,
wherein, if the medium identification information already has been recorded, then the medium identification information identical with the one that has already been recorded is recorded in the area in the step of recording the medium identification information.

16. The recording/reproducing method according to claim 9, further comprising:
a step of determining whether medium identification information has been recorded in the area where the structural characteristic information is recorded on the recording medium and storing the medium identification information in a memory if the medium identification information has been recorded;
a step of formatting the recording medium; and
a step of recording the medium identification information stored in the memory again in the area where the structural characteristic information is recorded after the formatting step is complete.

17. A recording/reproducing method comprising:
a step of accessing an area where structural characteristic information of a recording medium is recorded within a management data area on the recording medium; and
a step of reproducing medium identification information that has been recorded repeatedly in a plurality of locations in the area where the structural characteristic information is recorded and that enables the recording medium to be distinguished from another recording medium from at least one of the plurality of locations.

18. The recording/reproducing method according to claim 17,
wherein the step of reproducing the medium identification information includes a step of trying reproduction of the medium identification information again by accessing another one of the plurality of locations if there is a reproduction error in one of the plurality of locations.

19. The recording/reproducing method according to claim 17,
wherein the step of reproducing the medium identification information includes
a step of reproducing all of the structural characteristic information recorded in a plurality of locations of the recording medium,
a step of performing an error correction operation to the reproduced structural characteristic information, and
a step of extracting medium identification information from structural characteristic information that has undergone the error correction operation and been reproduced normally.

20. The recording/reproducing method according to claim 19, further comprising:
a step of counting the number of pieces of structural characteristic information that have undergone the error correction operation and been reproduced normally and determining that there is an abnormality in the recording medium if the number does not satisfy a predetermined standard.

21. A recording medium on which information is recorded, comprising:
a user data area where user data is recorded and a management data area where management data is recorded,
wherein medium identification information that enables the recording medium to be distinguished from another recording medium is recorded repeatedly in a plurality of locations in an area where structural characteristic information of the recording medium is recorded within the management data area.

22. The recording medium according to claim 21,
wherein the area where the structural characteristic information is recorded is provided in an error correction unit made of a plurality of sectors of the recording medium.

23. The recording medium according to claim 22, wherein the error correction unit is an ECC block.

24. A host device that instructs a recording/reproducing device to record and reproduce information using a recording medium, comprising:
a sending/receiving portion for sending and receiving information to and from the recording/reproducing device, and
an identification information generating portion for generating at least part of the medium identification information that enables the recording medium to be distinguished from another recording medium, the medium identification information being recorded repeatedly in a plurality of locations in an area where structural characteristic information of the recording medium is recorded within a management data area of the recording medium.
